(19) United States
(12) Patent Application Publication
(10) Pub. No.: US 2014/0078098 A1
(43) Pub. Date: Mar. 20, 2014

(54) TOUCH PANEL

(71) Applicant: SAMSUNG ELECTRO-MECHANICS CO., LTD., Suwon (KR)

(72) Inventors: Youn Soo Kim, Suwon (KR); Seung Min Lee, Suwon (KR); Ho Joan Park, Suwon (KR); Sang Hwan Oh, Suwon (KR)

(73) Assignee: SAMSUNG ELECTRO-MECHANICS CO., LTD., Suwon (KR)

(21) Appl. No.: 13/735,205

(22) Filed: Jan. 7, 2013

(30) Foreign Application Priority Data
Sep. 18, 2012 (KR) 10-2012-0103468

(51) Int. Cl. G06F 3/041

(52) U.S. Cl. CPC G06F 3/041
USPC 345/174

(57) ABSTRACT

Disclosed herein is a touch panel, including: a transparent substrate having a first refractive index; a high refractive index layer formed on one surface of the transparent substrate and having a second refractive index higher than the first refractive index; a low refractive index layer formed on the other surface of the transparent substrate and having a third refractive index lower than the first refractive index; and a metal electrode formed on an exposed surface of the low refractive index layer.

### CROSS REFERENCE TO RELATED APPLICATION

This application claims the benefit of Korean Patent Application No. 10-2012-0103468, filed on Sep. 18, 2012, entitled “Touch Panel and Method for Manufacturing the Same”, which is hereby incorporated by reference in its entirety into this application.

### BACKGROUND OF THE INVENTION

1. Technical Field

The present invention relates to a touch panel.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

While the rapid advancement of an information-oriented society has widened the use of computers more and more, it is difficult to efficiently operate products using only a keyboard and a mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of an image display device such as an electronic organizer, a flat panel display device including a liquid crystal display (LCD) device, a plasma display panel (PDP), an electroluminescence (El) element, or the like, and a cathode ray tube (CRT) to thereby be used to allow users to select desired information while viewing the image display device.

In addition, the touch panel is classified into a resistive type touch panel, a capacitive type touch panel, an electromagnetic type touch panel, a surface acoustic wave (SAW) type touch panel, and an infrared type touch panel. These various types of touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

In the touch panel according to the prior art, the sensing electrode is formed as indium tin oxide (ITO). However, the ITO has excellent electric conductivity, but since indium that is a raw material is expensive rare earth metal and is expected to be depleted within about 10 years, cannot be smoothly supplied.

For this reason, as in the touch panel described in Korean Laid-Open Publication No. 10-2011-0120157, researches for forming electrodes using metals have been actively conducted. The electrode made of metals has an advantage in that metal has excellent electric conductivity than ITO and a supply and demand of metals is smooth, as compared with ITO. However, the touch panel configured of the electrode has a disadvantage in that when the electrode is visually recognized or is irradiated with light from the outside, the glittering phenomenon occurs in the electrode to degrade the visibility of the touch panel.

### SUMMARY OF THE INVENTION

The present invention has been made in an effort to provide a touch panel with improved visibility by preventing an electrode made of metals from being visually recognized and a mirror phenomenon at the electrode.

According to a preferred embodiment of the present invention, there is provided a touch panel, including: a transparent substrate having a first refractive index; a high refractive index layer formed on one surface of the transparent substrate and having a second refractive index higher than the first refractive index; a low refractive index layer formed on the other surface of the transparent substrate and having a third refractive index lower than the first refractive index; and a metal electrode formed on an exposed surface of the low refractive index layer.

The transparent substrate may be window glass.

The second refractive index may be 1.68 to 1.93.

The third refractive index may be 1.3 to 1.5.

The high refractive index layer may include metal oxide and ultraviolet curable resin.

The metal oxide may include titanium oxide or zirconium oxide.

The low refractive index layer may include silica particle and ultraviolet curable resin.

The silica particle may include colloidal silica particle or hollow silica particle.

A thickness of the high refractive index layer may be 50 to 100 nm.

A thickness of the low refractive index layer may be 50 to 100 nm.

The metal electrode may be formed of copper (Cu), aluminum (Al), gold (Au), molybdenum (Mo), nickel (Ni), silver (Ag), titanium (Ti), palladium (Pd), and chromium (Cr), or a combination thereof.

The metal electrode may be formed of metal silver that is formed by exposing/developing a silver salt emulsion layer.

The metal electrode may be formed in a mesh pattern.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a touch panel according to a preferred embodiment of the present invention;

FIG. 2 is a cross-sectional view of a structure in which the touch panel illustrated in FIG. 1 is combined with a display unit; and

FIG. 3 is a cross-sectional view of a structure in which the touch panel illustrated in FIG. 1 is provided with a functional layer.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

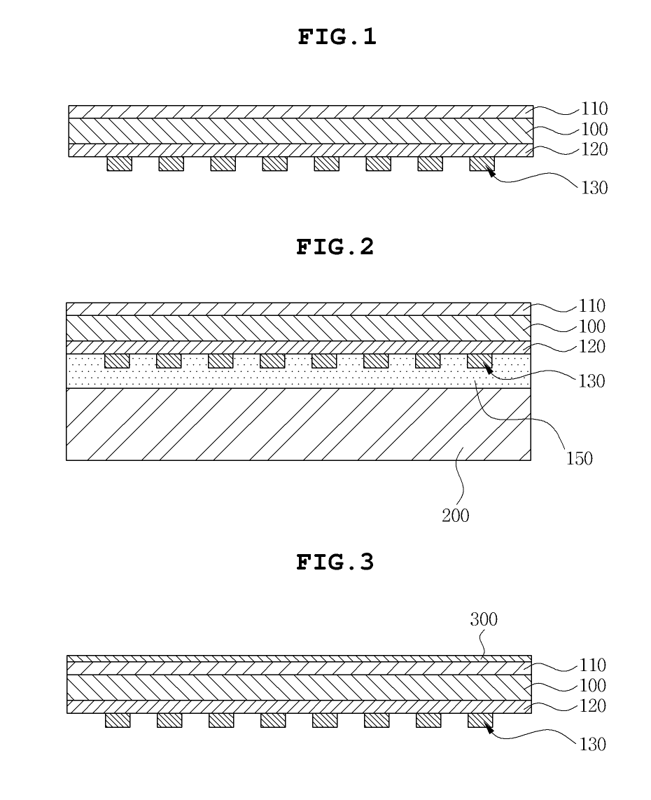

Hereinafter, preferred embodiments of the present invention will be described in detail with reference to the attached drawings. FIG. 1 is a cross-sectional view of a touch panel according to a preferred embodiment of the present invention.

As illustrated in FIG. 1, a touch panel according to a preferred embodiment of the present invention includes a transparent substrate 100 having a first refractive index, a high refractive index layer 110 formed on one surface of the transparent substrate 100 and having a second refractive index higher than the first refractive index, a low refractive index layer 120 formed on the other surface of the transparent substrate 100 and having a third refractive index lower than the first refractive index, and a metal electrode 130 formed on an exposed surface of the low refractive index layer 120.

The transparent substrate 100 needs to have transparency so that an image provided from a display unit 200 (see FIG. 2) can be recognized by a user. In consideration of the transparency described above, the transparent substrate 100 may be made of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, or tempered glass.

In particular, the transparent substrate 100 may be window glass that is provided at an outermost side of the touch panel. When the transparent substrate 100 is the window glass, the electrode is directly formed on the window glass and therefore, a process for manufacturing a touch panel may not include a process for forming an electrode on a separate substrate and then, attaching the electrode to the window glass, thereby reducing the overall thickness of the touch panel. Meanwhile, the transparent substrate 100 has a difference in relative refractive indexes as compared with the high refractive index layer 110 and the low refractive index layer 120 to be described below. In detail, when the transparent substrate 100 has the first refractive index, the high refractive index layer 110 to be described below has the second refractive index higher than the first refractive index and the low refractive index layer 120 has a third refractive index lower than the first refractive index.

In order to describe in more detail the difference in the refractive indexes, the high refractive index layer 110 and the low refractive index layer 120 will be first described in detail.

The high refractive index layer 110 is formed on one surface of the transparent substrate 100. The high refractive index layer 110 may include metal oxide and ultraviolet curable resin. In this case, metal oxide may include titanium oxide or zirconium oxide, wherein an average particle size of the metal oxide may be 5 to 40 nm. Further, the ultraviolet curable resin may be a multi-functional monomer having any one functional group selected from a group consisting of acryloyl group, methacryloyl group, and fluoroalkyl group, oligomer, or polymer, and poly dialkyl siloxane.

The low refractive index layer 120 is formed on the other surface of the transparent substrate 100. The low refractive index layer 120 may include silica particle and ultraviolet curable resin. In this case, the silica particle may include colloidal silica particle or hollow silica particle. In this case, a particle size of the silica particle may be 10 to 50 nm. Further, the ultraviolet curable resin may be a multi-functional monomer having any one functional group selected from a group consisting of vinyl group, allyl group, acryloyl group, methacryloyl group, and isopropenyl, oligomer, or polymer.

The high refractive index layer 110 and the low refractive index layer 120 have a different refractive index from the transparent substrate 100. In detail, the high refractive index layer 110 may have a refractive index of about 1.68 to 1.93 and the low refractive index layer 120 may have a refractive index of about 1.3 to 1.5. That is, the second refractive index may be 1.68 to 1.93 and the third refractive index may be 1.3 to 1.5. In this case, the refractive index of the transparent substrate 100, that is, the first refractive index is lower than the second refractive index and higher than the third refractive index.

Meanwhile, the metal electrode 130 is formed on the exposed surface of the low refractive index layer 120. The metal electrode 130 generates a signal when being touched by a user so as to allow a controller (not illustrated) to recognize touched coordinates.

The metal electrode 130 may be formed of any one selected from copper (Cu), aluminum (Al), gold (Au), silver (Ag), titanium (Ti), palladium (Pd), and chromium (Cr), or a combination thereof In this case, the metal electrode 130 may be formed by methods such as plating, deposition, and the like.

The metal electrode 130 may also be formed of metal silver formed by exposing/developing a silver salt emulsion layer, in addition to the foregoing metals.

Further, the metal electrode 130 may be formed in a mesh pattern at the exposed surface of the low refractive index layer 120.

In the preferred embodiment of the present invention, the metal electrode 130 is formed on the exposed surface of the low refractive index layer 120. Therefore, in order to visualize the metal electrode 130 from the outside, light reflected from the metal electrode 130 needs to pass through the low refractive index layer 120, the transparent substrate 100, and the high refractive index layer 110. In other words, the external light transmits through the high refractive index layer 110, the transparent substrate 100, and the low refractive index layer 120 and then, reaches the metal electrode 130.

However, in the preferred embodiment of the present invention, since the high refractive index layer 110 and the low refractive index layer 120 are each formed on one surface and the other surface of the transparent substrate 100, when light transmits the high refractive index layer 110 and reaches the surface of the transparent substrate 100 and light transmitting the transparent substrate 100 reaches the surface of the low refractive index layer 120, light reflection occurs due to the difference in refractive indexes.

Further, as the light reflection is introduced, that is, as the light introduction into the metal electrode 130 is interrupted, a degree of the light reflection is reduced at the metal electrode 130. Therefore, the metal electrode 130 may not be recognized from the outside and the visibility badness problem of the touch panel due to the mirror phenomenon at the metal electrode 130 can be solved.

An experiment for confirming the effect was conducted. The experimental results will be described in detail with reference to the experimental data shown in the following Table 1 and Table 2.

First, describing the conditions of an experiment, when lux uses a light source of approximate 800 1× or more, it was observed whether the metal electrode 130 is visualized and a person having corrected eyesight of 1.0 or more is participated as an observer. An observer performs observation while looking straight onto a sample at a distance of 20 to 30 cm from the sample. In this case, the sample was vertically tilted in a range of 30°. The observation time was set to be 30 seconds. The transparent substrate 100 used PET having a refractive index of 1.63 and the metal electrode 130 was formed in a mesh pattern having a line width of 5 μm and a pitch of 300 μm and thus, was an observation object of visualization or not.

Meanwhile, in the ‘visualized or not’ of the following ‘Table 1’, ⊚ shows ‘the metal electrode 130 is seen well’ and ‘◯’ shows ‘the metal electrode is seen’. In addition, Δshows ‘the metal electrode 130 is slightly seen’ and ‘×’ shows ‘the metal electrode 130 is not seen’. Further, the division is the same even in the ‘visualization or not’ of the following ‘Table 2’.

TABLE 1

| First | Second | Third | | |
|---|---|---|---|---|
| Refractive | Refractive | Refractive | Transmittance | Visualization |
| Index | Index | Index | (%) | or not |
| 1.63 | — | — | 91.5 | ⊚ |
| 1.63 | 1.68 | 1.58 | 89.2 | ⊚ |
| 1.63 | 1.68 | 1.5 | 88.6 | ◯ |
| 1.63 | 1.68 | 1.47 | 88.1 | ◯ |
| 1.63 | 1.68 | 1.41 | 87.4 | X |
| 1.63 | 1.68 | 1.36 | 86.8 | Δ |
| 1.63 | 1.68 | 1.3 | 85.9 | Δ |
| 1.63 | 1.74 | 1.5 | 87.9 | Δ |
| 1.63 | 1.86 | 1.5 | 86.2 | X |
| 1.63 | 1.93 | 1.5 | 84.8 | X |

As illustrated in [Table 1], as the case in which the refractive index of the transparent substrate 100, that is, the first refractive index is 1.63, in the case in which the high refractive index layer 110 and the low refractive index layer 120 are not formed, the metal electrode 130 was shown as being seen well. In addition, as the case in which the high refractive index layer 110 and the low refractive index layer 120 are formed, even in the case in which the second refractive index is 1.68 and the third refractive index is 1.58, 1.5, and 1.47 that do not have a large difference from the first refractive index, the metal electrode 130 was shown as being seen.

However, as the case in which the second refractive index is 1.68, in the case in which the third refractive index is 1.41, 1.36, and 1.3, the metal electrode 130 was slightly seen or shown as being not seen.

Further, in the case in which the second refractive index is 1.74, 1.86, and 1.93 that is higher than 1.68, even in the case in which the third refractive index is 1.5, the metal electrode 130 was slightly seen or shown as being not seen. Here, the metal electrode 130 is shown as being not seen, as the second refractive index is higher than 1.68. However, when the second refractive index is too high, the transmittance is low and therefore, the second refractive index may be 1.93 or less.

Therefore, in consideration of the experimental result, the second refractive index may be 1.68 to 1.93 and the third refractive index may be 1.3 to 1.5.

Meanwhile, the following ‘Table 2’ shows experimental data obtained by testing the transmittance of the touch panel and whether the metal electrode 130 is visualized when the thicknesses of the high refractive index layer 110 and the low refractive index layer 120 are different from each other.

TABLE 2

| High Refractive | | Low Refractive | | | |
|---|---|---|---|---|---|
| Index Layer | | Index Layer | | | |
| Second | | Third | | Trans- | |
| Refractive | Thickness | Refractive | Thickness | mittance | Visualization |
| Index | (nm) | Index | (nm) | (%) | or not |
| 1.68 | 20 | 1.5 | 50 | 88.9 | ◯ |
| 1.68 | 30 | 1.5 | 50 | 88.7 | ◯ |
| 1.68 | 50 | 1.5 | 50 | 88.6 | ◯ |
| 1.68 | 100 | 1.5 | 50 | 88.6 | ◯ |
| 1.68 | 150 | 1.5 | 50 | 88.6 | ◯ |
| 1.68 | 50 | 1.5 | 20 | 89.1 | ◯ |
| 1.68 | 50 | 1.5 | 30 | 88.9 | ◯ |
| 1.68 | 50 | 1.5 | 50 | 88.6 | ◯ |
| 1.68 | 50 | 1.5 | 100 | 88.6 | ◯ |
| 1.68 | 50 | 1.5 | 150 | 88.6 | ◯ |

It can be appreciated from [Table 2] that the transmittance and whether the metal electrode 130 is visualized are not affected by the thickness of the high refractive index layer 110 and the low refractive index layer 120. In other words, the transmittance and whether the metal electrode 130 is visualized may be affected by the refractive indexes of the high refractive index layer 110 and the low refractive index layer 120. The reason is that the refraction of light is performed at the interface between layers. However, when considering the manufacturing costs or the thickness of the touch panel, the high refractive index layer 110 and the low refractive index layer 120 may each have a thickness of 50 to 100 nm.

FIG. 2 is a cross-sectional view of a structure in which the touch panel according to the preferred embodiment of the present invention is combined with a display unit 200. The display unit 200 may be attached to the low refractive index layer 120 in the exposed surface direction of the low refractive index layer 120. An adhesive layer 150 may be formed between the low refractive index layer 120 and the display unit 200 so that the display unit 200 is attached to the touch panel and the adhesive layer 150 may be, for example, an optical clear adhesive (OCA).

FIG. 3 is a cross-sectional view of a structure in which the touch panel according to the preferred embodiment of the present invention is further provided with a functional layer 300. The functional layer 300 may be various known functional layers 300 that may provide a predetermined function to the touch panel, such as a fingerprint preventing layer, a hard coat layer, and the like.

According to the preferred embodiments of the present invention, it is possible to interrupt light introduced into the metal electrode as the light reflection is induced due to the difference in refractive indexes to prevent the metal electrode from being visualized from the outside and the mirror phenomenon at the metal electrode, thereby improving the visibility of the touch panel.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel, comprising:
a transparent substrate having a first refractive index;
a high refractive index layer formed on one surface of the transparent substrate and having a second refractive index higher than the first refractive index;
a low refractive index layer formed on the other surface of the transparent substrate and having a third refractive index lower than the first refractive index; and
a metal electrode formed on an exposed surface of the low refractive index layer.

2. The touch panel as set forth in claim 1, wherein the transparent substrate is window glass.

3. The touch panel as set forth in claim 1, wherein the second refractive index is 1.68 to 1.93.

4. The touch panel as set forth in claim 1, wherein the third refractive index is 1.3 to 1.5.

5. The touch panel as set forth in claim 1, wherein the high refractive index layer includes metal oxide and ultraviolet curable resin.

6. The touch panel as set forth in claim 5, wherein the metal oxide includes titanium oxide or zirconium oxide.

7. The touch panel as set forth in claim 1, wherein the low refractive index layer includes silica particle and ultraviolet curable resin.

8. The touch panel as set forth in claim 1, wherein the silica particle includes colloidal silica particle or hollow silica particle.

9. The touch panel as set forth in claim 1, wherein a thickness of the high refractive index layer is 50 to 100 nm.

10. The touch panel as set forth in claim 1, wherein a thickness of the low refractive index layer is 50 to 100 nm.

11. The touch panel as set forth in claim 1, wherein the metal electrode is formed of copper (Cu), aluminum (Al), gold (Au), molybdenum (Mo), nickel (Ni), silver (Ag), titanium (Ti), palladium (Pd), and chromium (Cr), or a combination thereof.

12. The touch panel as set forth in claim 1, wherein the metal electrode is formed of metal silver that is formed by exposing/developing a silver salt emulsion layer.

13. The touch panel as set forth in claim 1, wherein the metal electrode is formed in a mesh pattern.
